(19) United States
(12) Patent Application Publication
(10) Pub. No.: US 2022/0173916 A1
(43) Pub. Date: Jun. 2, 2022

(54) APPARATUS AND METHOD FOR MANAGING HISTORY OF OBJECT OWNER

(71) Applicant: Electronics and Telecommunications Research Institute, Daejeon (KR)

(72) Inventors: Seok-Hyun KIM, Daejeon (KR); Geon-Woo KIM, Daejeon (KR); Soo-Hyung KIM, Daejeon (KR); Young-Sam KIM, Daejeon (KR); Jong-Hyouk NOH, Daejeon (KR); Kwan-Tae CHO, Daejeon (KR); Sang-Rae CHO, Daejeon (KR); Young-Seob CHO, Daejeon (KR); Jin-Man CHO, Daejeon (KR); Seung-Hun JIN, Daejeon (KR)

(73) Assignee: Electronics and Telecommunications Research Institute, Daejeon (KR)

(21) Appl. No.: 17/334,348

(22) Filed: May 28, 2021

(30) Foreign Application Priority Data
Nov. 30, 2020 (KR) 10-2020-0165129

(51) Int. Cl. H04L 9/32

(52) U.S. Cl. CPC H04L 9/3265; H04L 2209/38; H04L 9/321; H04L 9/3236

(57) ABSTRACT

Disclosed herein are an apparatus and method for managing a history of object owners. The method includes generating, by an object owner history management apparatus, a product registration Verifiable Credential (VC) in a form of a Merkle tree, and registering the product registration VC in a blockchain in order to manage a history of owners of an object, acquiring, by a first user terminal device, the product registration VC from the blockchain and registering a first owner VC, generated based on the product registration VC, in the blockchain to register an ownership of the object, and acquiring, by a second user terminal device, a product transfer Verifiable Presentation (VP) from the first user terminal device and registering a second owner VC, generated based on the product transfer VP, in the blockchain to receive transfer of the ownership of the object.

### CROSS REFERENCE TO RELATED APPLICATION

This application claims the benefit of Korean Patent Application No. 10-2020-0165129, filed Nov. 30, 2020, which is hereby incorporated by reference in its entirety into this application.

### BACKGROUND OF THE INVENTION

### 1. Technical Field

The present invention relates generally to blockchain technology and, more particularly to technology for managing a history of owners of an object using a blockchain.

### 2. Description of the Related Art

Recently, various online transaction services have been provided. The major function provided by online transaction services is a secure article transaction service between a consumer and a seller. However, an online transaction service guarantees transaction reliability between a consumer and a seller, but cannot guarantee the history of usage of the article to be sold, and thus fraudulent transactions with regard to various articles are currently occurring. Therefore, there is a need to provide secure commercial transaction service by verifying and managing the histories of owners of objects, such as all articles which are distributed by commercial transaction services.

Meanwhile. Korean Patent No. 10-2116325 “Certification System for Honest Goods and Transaction Based on Blockchain” discloses a system and method for certifying an authentic article and a transaction based on a blockchain, which can immediately and conveniently certify online whether an article is an authentic article and certify a transaction history of the corresponding article through a mobile terminal or the like.

### SUMMARY OF THE INVENTION

Accordingly, the present invention has been made keeping in mind the above problems occurring in the prior art, and an object of the present invention is to provide secure commercial transaction service by verifying and managing histories of owners (holders) of objects, such as all articles distributed through commercial transaction services.

Another object of the present invention is to apply the technology of the present invention to various types of history management services as well as to the management of histories of owners of objects.

In accordance with an aspect of the present invention to accomplish the above objects, there is provided a method for managing a history of object owners using an object owner history management apparatus, the method including generating, by the object owner history management apparatus, a product registration Verifiable Credential (VC) in a form of a Merkle tree, and registering the product registration VC in a blockchain in order to manage a history of owners of an object that is a product; acquiring, by a first user terminal device, the product registration VC from the blockchain and registering a first owner VC, generated based on the product registration VC, in the blockchain in order to register an ownership of the object, and acquiring, by a second user terminal device, a product transfer Verifiable Presentation (VP) from the first user terminal device and registering a second owner VC, generated based on the product transfer VP, in the blockchain in order to receive transfer of the ownership of the object.

Registering the product registration VC may be configured such that the object owner history management apparatus generates the product registration VC including a hash value obtained by including an identifier of the product registration VC in each of a Merkle root and a transaction of the Merkle tree and by performing hashing on included results thereof.

Registering the product registration VC may be configured such that the blockchain records the product registration VC in the blockchain so that the hash value of the identifier of the product registration VC corresponds to a key for searching for the product registration VC.

Registering the product registration VC may be configured such that the object owner history management apparatus generates a Quick Response (QR) code including access information required to access the product registration VC recorded in the blockchain.

Registering the first owner VC may be configured such that the first user terminal device acquires the hash value of the identifier of the product registration VC from the object owner history management apparatus and acquires the product registration VC from the blockchain using the hash value of the identifier of the product registration VC as a key.

Registering the first owner VC may be configured such that the first user terminal device generates the first owner VC by including the identifier of the product registration VC in a transaction that is used as evidence information for proving that the first owner is an initial owner of the object.

Registering the first owner VC may be configured such that the first user terminal device generates the first owner VC from a hash value obtained by hashing the identifier of the product registration VC and an identifier of the first owner VC.

Registering the first owner VC may be configured such that the first user terminal device transmits a hash value of a serial number of the object acquired from the product registration VC and the first owner VC to the blockchain, and the blockchain registers the first owner VC and records the first owner as an initial owner in a history of owners based on the serial number.

Registering the second owner VC may be configured such that the second user terminal device provides a decentralized identifier thereof to the first user terminal device so as to receive transfer of ownership of the object.

Registering the second owner VC may be configured such that the first user terminal device generates evidence information for transferring an ownership of the object using a decentralized identifier of the first user terminal device and a decentralized identifier of the second user terminal device, and generates the product transfer VP including the evidence information and the first owner VC.

Registering the second owner VC may be configured such that the second user terminal device retrieves a history of owners of the object from the blockchain using the hash value of the identifier of the first owner VC included in the product transfer VP.

Registering the second owner VC may be configured such that the second user terminal device generates the second owner VC by including an identifier of the product transfer VP in a transaction that is used as evidence information for transferring an ownership of the object.

Registering the second owner VC may be configured such that the second user terminal device generates the second owner VC including a hash value, obtained by hashing the identifier of the product transfer VP and an identifier of the second owner VC, and a hash value, obtained by hashing the identifier of the first owner VC.

Registering the second owner VC may be configured such that the second user terminal device transmits a hash value of a serial number of the object acquired from the first owner VC, the product transfer VP, and the second owner VC to the blockchain, and the blockchain registers the second owner VC and records the second owner as a transferee in the history of owners based on the serial number.

In accordance with another aspect of the present invention to accomplish the above objects, there is provided an apparatus for managing a history of object owners, including one or more processors; and an execution memory for storing at least one program that is executed by the one or more processors, wherein the at least one program is configured to, in order to manage a history of owners of an object that is a product, generate a product registration Verifiable Credential (VC) in a form of a Merkle tree, register the product registration VC in a blockchain, register the product registration VC in the blockchain, and provide an identifier of the product registration VC for accessing the blockchain to a user terminal device desiring to register an ownership of the object.

The user terminal device may be configured to acquire the product registration VC from the blockchain in order to register ownership of the object, and register a first owner VC, generated based on the product registration VC, in the blockchain, and acquire a product transfer Verifiable Presentation (VP) from a user terminal device of an initial owner and register a second owner VC, generated based on the product transfer VP, in the blockchain in order to receive transfer of the ownership of the object.

The at least one program may be configured to generate the product registration VC including a hash value obtained by including an identifier of the product registration VC in each of a Merkle root and a transaction of the Merkle tree and by performing hashing on included results thereof.

The first owner VC may include an identifier of the product registration VC in a transaction that is used as evidence information for proving that the first owner is an initial owner of the object.

The second owner VC may include an identifier of the product transfer VP in a transaction that is used as evidence information for transferring an ownership of the object.

The second owner VC may correspond to a hash value obtained by hashing the identifier of the product transfer VP and an identifier of the second owner VC and a hash value obtained by hashing an identifier of the initial owner VC of the initial owner.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a system for managing a history of object owners according to an embodiment of the present invention;

FIG. 2 is a block diagram illustrating an apparatus for managing a history of object owners according to an embodiment of the present invention;

FIG. 3 is a block diagram illustrating a user terminal device according to an embodiment of the present invention:

FIG. 4 is a block diagram illustrating a blockchain system according to an embodiment of the present invention:

FIG. 5 is a block diagram illustrating a Merkle tree of an initial owner Verifiable Credential (VC) according to an embodiment of the present invention:

FIG. 6 is a block diagram illustrating a Merkle tree of a transferee VC according to an embodiment of the present invention:

FIG. 7 is an operation flowchart illustrating a method for managing a history of object owners according to an embodiment of the present invention;

FIG. 8 is a sequence diagram illustrating a product registration process according to an embodiment of the present invention:

FIG. 9 is a sequence diagram illustrating a product owner registration process according to an embodiment of the present invention:

FIG. 10 is a sequence diagram illustrating a product owner transfer process according to an embodiment of the present invention:

FIG. 11 is a sequence diagram illustrating a product owner history retrieval process according to an embodiment of the present invention; and

FIG. 12 is a diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, preferred embodiments of the present invention will be described in detail with reference to the attached drawings.

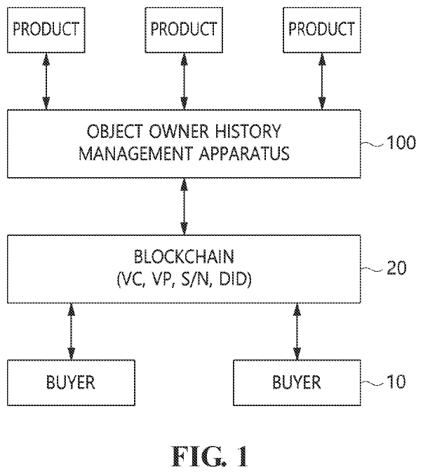

FIG. 1 is a block diagram illustrating a system for managing a history of object owners according to an embodiment of the present invention.

Referring to FIG. 1, the system for managing a history of object owners according to the embodiment of the present invention includes products, a user terminal device 10 of a purchaser (a buyer), a blockchain 20, and an apparatus 100 for managing a history of object owners (hereinafter referred to as “object owner history management apparatus 100”).

The blockchain 20 may provide a Decentralized Identifier (DID) management smart contract function of registering, retrieving, updating, and deleting DID documents of all entities, a serial number (S/N) management smart contract function of managing Verifiable Credential (VC) information of a recent owner of each product, and a Verifiable Credential (VC)/Verifiable Presentation (VP) management smart contract function of managing a product registration VC and an owner registration and transfer VC.

A manufacturer may assign Decentralized Identifiers (DID) and serial numbers (S/N) to produced products through the object owner history management apparatus 100, may issue product registration Verifiable credentials (VC), and may register the product registration VC in the blockchain 20.

Here, the object owner history management apparatus 100 creates a Quick Response (QR) code that contains detailed information of each product and information enabling the product registration VC to be retrieved, and the manufacturer may sell the corresponding product, in the state in which a QR code is packaged therewith.

A purchaser (buyer) may check product-related information, such as the S/N of the product, a product registration VC retrieval ID, manufacturer information, and a product image, by reading the QR code enclosed with the purchased product using the user terminal device 10, and may verify whether the purchased product is an authentic product based on the checked product-related information.

Here, the user terminal device 10 may generate an initial owner VC that is capable of certifying that the owner of the corresponding product is a user himself or herself, may register the initial owner VC in the blockchain 20, and may prove whether the user is the owner of the product when the corresponding product is sold in the future.

Here, the user terminal device 10 may verify whether a third party is the owner of a corresponding product when the buyer receives transfer of the product from the third party, may generate a transferee VC by which it can be proved whether the owner of the product has been transferred, and may register the transferee VC in the blockchain 20.

Further, the user terminal device 10 may retrieve a history of owners of the corresponding product using only the serial number of the product.

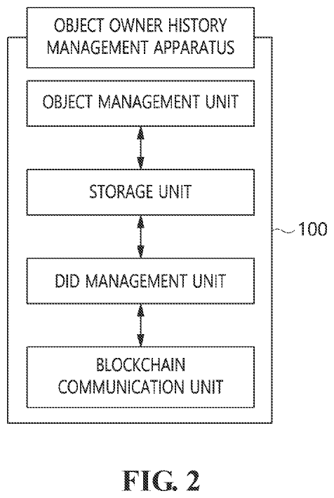

FIG. 2 is a block diagram illustrating an apparatus for managing a history of object owners according to an embodiment of the present invention.

Referring to FIG. 2, the object owner history management apparatus according to the embodiment of the present invention may include an object management unit, a storage unit, a DID management unit, and a blockchain communication unit.

The object management unit may generate and manage the serial number of a corresponding product, and may provide a web service Uniform Resource Locator (URL) through which product-related information can be provided.

Here, the object management unit may provide a function of generating a QR code containing the product-related information so that a product buyer can easily check product information.

Here, the object management unit may generate a QR code including all product information and enclose the QR code with the product unless a manufacturer is in an environment in which it is difficult to operate a web service for providing product information.

Here, the object management unit may provide a function of generating a product registration VC.

The storage unit may provide a function of managing the product information.

Here, the product information may include various types of information required for buyers who purchase the corresponding product, such as the serial number (S/N) of a corresponding product, an ID hash value of the product registration VC, a product name, a product image, a manufacturer name, and a manufacturer contact number. The product information may be managed as a randomly generated random key, and the random key information may be checked through the QR code enclosed with the product.

The DID management unit may provide a function of generating and managing a Decentralized Identifier (DID) and a DID document of a user terminal.

The blockchain communication unit may provide a function of registering, retrieving, updating, and deleting the DID document in/from a blockchain and a function of registering and retrieving VC-related information.

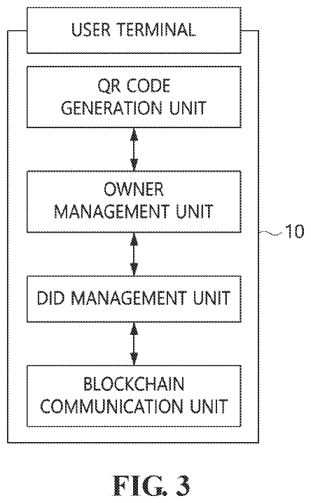

FIG. 3 is a block diagram illustrating a user terminal device according to an embodiment of the present invention.

A QR code generation unit may provide a function of reading a QR code containing product-related information and checking product information and a function of generating a QR code from the Decentralized ID (DID) information and Verifiable Presentation (VP) of a user terminal and outputting the QR code.

An owner management unit may provide a function of generating an initial owner VC for a product, a function of generating a product transfer Verifiable Presentation (VP), a function of generating a transferee VC, and a function of retrieving owner information.

Here, the owner management unit may provide a function of receiving the serial number of the corresponding product and checking information about an initial owner and a recent owner of the corresponding product in the sequence of time spans from the production (manufacture) date of the product.

A DID management unit may provide a function of generating and managing the DID and the DID document of the user terminal.

A blockchain communication unit may provide a function of registering, retrieving, updating, and deleting the DID document in or from a blockchain and a function of registering and retrieving VC-, VP-, and S/N-related information.

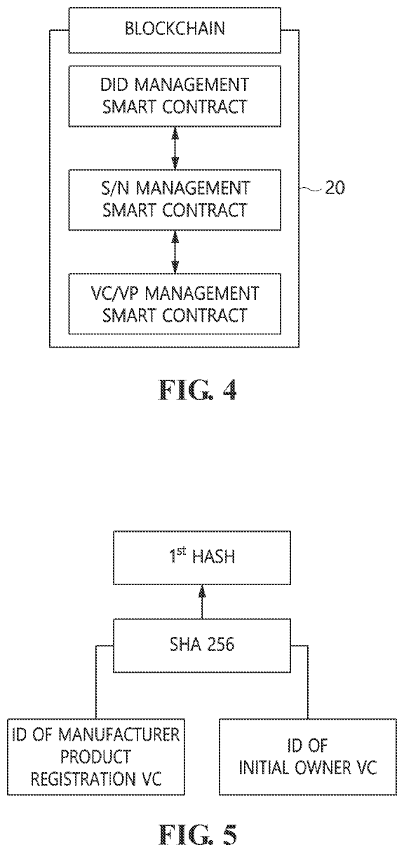

FIG. 4 is a block diagram illustrating a blockchain system according to an embodiment of the present invention.

Referring to FIG. 4, the blockchain system according to the embodiment of the present invention may include a DID management smart contract, an S/N management smart contract, and a VC/VP management smart contract.

The DID management smart contract may provide a function of registering, retrieving, updating, and deleting DID documents.

The S/N management smart contract may provide a function of managing information about the identifier of the most recent owner VC based on the serial number of the corresponding product and retrieving a history of all owners of the corresponding product.

The VC/VP management smart contract may provide a function of verifying signatures for VC and VP and verifying Merkle tree information.

FIG. 5 is a block diagram illustrating the Merkle tree of an initial owner Verifiable Credential (VC) according to an embodiment of the present invention.

Referring to FIG. 5, all VC information generated in the present invention may include Merkle root (merkleRoot) information and transaction (previousTx) information. It can be seen that, based on the initial owner VC illustrated in FIG. 5, merkleRoot is a first (1^{st}) hash value and previousTx is a value obtained by hashing the ID of a product registration VC for a manufacturer in SHA256.

Here, it can be seen that the initial owner VC corresponds to the 1^{st} hash value obtained by hashing the ID of the manufacturer product registration VC and the ID of the initial owner VC.

A Merkle tree or hash tree structure may use SHA-256 encryption technology (a hash function) for convenient and definite data certification, and a top parent node (or root node) of the Merkle tree may be called “Merkle root (merkleRoot)” and may be referred to as a hash tree of transactions stored in the block of the blockchain.

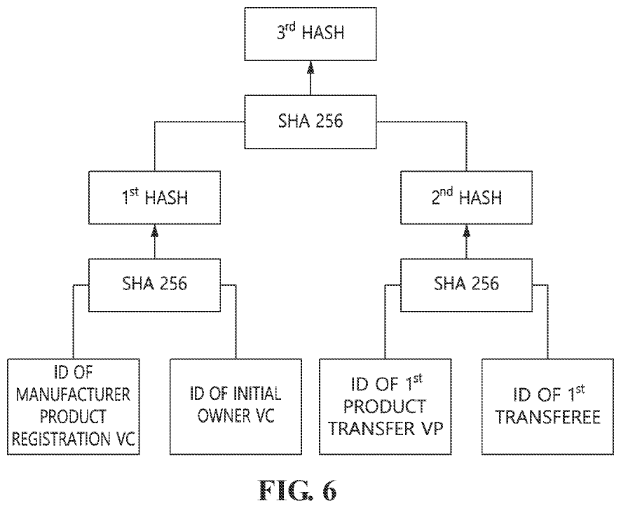

FIG. 6 is a block diagram illustrating the Merkle tree of a transferee VerifiableCredential (VC) according to an embodiment of the present invention.

Referring to FIG. 6, based on a 1^{st} transferee VC, merkleRoot may be a 3^{rd} hash value, and previousTx may be a value obtained by hashing the ID of an initial owner VC in SHA256.

Here, it can be seen that the transferee VC corresponds to a 3^{rd} hash value obtained by performing hashing on the 1^{st} hash value, which is obtained by hashing the ID of a manufacturer product registration VC and the ID of the initial owner VC, and a 2^{nd} hash value, which is obtained by hashing the ID of a 1^{st} product transfer VP and the ID of the first transferee VC.

The following pseudo code 1 is for showing an example of a product registration VC according to an embodiment of the present invention.

```
Pseudo Code 1
{
″@context″: [
  ″https://www.w3.org2018/credentials/v1″,
  ″https://www.w3.org2018/credentials/examples/v1″
  ],
″id″: ″http://manufacturer.com/credentials/1872″,
″type″: [″VerifiableCredential″, ″ProductCredential″],
″issuer″: ″did:manu:ebfeb1f712ebc6f1c276e12e.c21″,
″issuanceDate″: ″2010-01-10T19:23:24Z″,
″credentialSubject″: {
    “id” : ″did:manu:ebfeb1f712ebc6f1c276e12ec21#serialNumber″,
    “sn” : “serialNumber” ,
    “productName” : “sample-robot”
    “manufacturer” : etri,
    “manufactureDate” : “2010-01T19:33:24Z” ,
    “merkleRoot” :
  “141D5F71AB89AFC2D02C4D50DD58A2AD8F18A5667CB2DF35BE5670DAEA176985” ,
    “previousTx” :
  “141D5F71AB89AFC2D02C4D50DD58A2AD8F18A5667CB2DF35BE5670DAEA176985”
},
″proof″: {
  ″type″: ″RsaSignature2018″,
  ″created″: ″ 2010-01-10T19:43:24Z″,
  ″proofPurpose″: ″assertionMethod″,
  ″verificationMethod″: ″http://manufacturer.com/issuers/keys/1″,
  ″jws″:
″eyJhbGci0iJSUzI1NiIsImI2NC16ZmFsc2UsImNyaXQi01siYj0I19..TCYt5X
    s1TJX1CxPCT8yAV-TVk1Eq_PbCh0MqsLfRoPsnsgw5WEuts01mq-
pQy7UJiN5mgRxD-WUc
    X16dUEMG1v50aqzpqh4Qktb3rk-BuQy72IFL0qV0G_zS245-
kronKb78cPN25DG1cTwLtj
    PAYuNzVBAh4vGHSrQyHUdBBPM″
}
}
```

Referring to pseudo code 1, it can be seen that object owner history management apparatus 100 of a manufacturer generates and assigns a Decentralized Identifier (DID) for a product and issues a product registration VC for the corresponding product. The type of VC is composed of “VerifiableCredential” and “ProductCredential”, and may include the DID of the product, a serial number of the product, a product name, a manufacturer name, a manufacture date, merkleRoot, and previousTx information. Here, because merkleRoot and previousTx are Verifiable Credentials (VC) for the product, they may be set to the same value obtained by hashing the ID of the corresponding product registration VC in SHA256. In order to subsequently retrieve the history of all owners of the product, the VC information of a transferee is retrieved based on the previousTx, wherein VC retrieval may be repeatedly performed until a VC in which the Merkle root and the previousTx are identical to each other is retrieved.

The following pseudo code 2 is for showing an example of an initial product owner VC according to an embodiment of the present invention.

```
Pseudo Code 2
{
″@context″: [
  ″https://www.w3.org/2018/credentials/v1″,
  ″https://www.w3.org/2018/credentials/examples/v1″
  ].
″id″: ″did:user:aa76e12ec21ebfeb1f712ebc6aa/vc/1″,
″type″: [″VerifiableCredential″, ″DisputeCredential″ ,
″ProductOwnershipCredential″],
″issuer″: ″did:user:aa76e12ec21ebfeb1f712ebc6aa″,
″issuanceDate″: ″2010-02-10T19:23:24Z″,
″credentialSubject″: {
    “id” : ″http://manufacturer.com/credentials/1872″,
    “currentStatus” : “POR” ,
    “statusReason” : {
      “value” : “Product Owner Registration” ,
      “lang” : “en”
    }
    “purchaseDate” : “2010-02-01T19:33:24Z” ,
    “merkleRoot” :
96C8018AD5B2527D948CD233C2F93592F7C378A97F08186EF1A7A97BEA2B283F,
    “previousTx” :
  “141D5F71AB89AFC2D02C4D50DD58A2AD8F18A5667CB2DF35BE5670DEA176985”
},
″proof″: {
  ″type″: ″RsaSignature2018″,
  ″created″: ″ 2010-02-10T19:43:24Z″,
  ″proofPurpose″: ″assertionMethod″,
  ″verificationMethod″: ″ did:user:aa76e12ec21ebfeb1f712ebc6aa#keys-
1″,
  ″jws″:
″eyJhbGci0iJSUzI1NiIsImI2NCI6ZmFsc2UsImNyaXQi01siYjY0I119..TCYt5X
      sITJX1CxPCT8yAV-TVkIEq_PbCh0MqsLfRoPsnsgw5WEuts01mq-
pQy7UJiN5mgRxD-WUc
      X16dUEMG1v50aqzpqh4Qktb3rk-BuQy72IFL0qV0G_zS245-
kronKb78cPN25DG1cTwLtj
      PAYuNzVBAh4vGHSrQyHUdBBPM″
}
}
```

Referring to pseudo code 2, the initial product owner VC indicates VC information required by a buyer who initially purchases a corresponding product to verify, that the owner himself or herself of the product is the buyer.

The owner VC may be a VC for verifying that a specific user holds the ownership of a specific product registration VC starting at that time. The type of VC is composed of “VerifiableCredential”, “DisputeCredential”, and “ProductOwnershipCredential”, wherein DisputeCredential may correspond to a dispute about a specific credential.

Here, the user terminal device of the initial product owner may determine whether the initial owner VC of the corresponding product has been previously registered when registering the initial product owner VC in a blockchain, and may register the initial product owner VC only when the initial owner VC has not been registered. When the initial product owner VC of the corresponding product has been previously registered in the blockchain, the user terminal device of the owner to which the corresponding product is transferred may register the owner VC of the corresponding product as a product transferee VC in the blockchain. Further, the user terminal device of the initial product owner may search the blockchain for a VC associated with the specific product using ID information with reference to details in the field “credentialSubject” of the VC.

Further, in order for the user terminal device of the buyer to check whether the owner VC is an initial owner VC or a product transferee VC, when the value of “currentStatus” in the field “credentialSubject” of the VC is POR, the user terminal device may verify that the owner PC is an initial owner registration VC for the product, whereas, when the value of “currentStatus” is POT, the user terminal device may verify that the owner PC is a product transferee VC.

The following pseudo code 3 is for showing an example of a product transfer VP according to an embodiment of the present invention.

```
Pseudo Code 3
{
″@context″: [
  ″https://www.w3.org/2018/credentials/v1″,
  ″https://www.w3.org/2018/credentials/examples/v1″
  ],
″id″: ″did:user:aa76e12ec21ebfeb1f712ebc6aa/vp/1″,
″type″: [″VerifiablePresentation″, ″ProductTransferCredential″],
″verifiableCredential″:
{
″@context″: [
  ″https://www.w3.org/2018/credentials/v1″,
  ″https://www.w3.org/2018/credentials/examples/v1″
  ],
″id″: ″did:user:aa76e12ec21ebfeb1f712ebc6aa/vc/1″,
″type″: [″VerifiableCredential″, ″DisputeCredential″ ,
″ProductOwnershipCredential″],
″issuer″: ″did:user:aa76e12ec21ebfeb1f712ebc6aa″,
″issuanceDate″: ″2010-02-10T19:23:24Z″,
″credentialSubject″: {
    “id” : ″http://manufacturer.com/credentials/1872″,
    “currentStatus” : “POR” ,
    “statusReason” : {
      “value” : “Product Owner Registration” ,
      “lang” : “en”
    }
    “purchaseDate” : “2010-02-01T19:33:24Z” ,
    “merkleRoot” :
96C8018AD5B2527D948CD233C2F93592F7C378A97F08186EF1A7A97BEA2B283F,
    “previousTx” :
“141D5F71AB89AFC2D02C4D50DD58A2AD8F18A5667CB2DF35BE5670DAEA176985”
},
″proof″: {
  ″type″: ″RsaSignature2018″,
  ″created″: ″ 2010-10T19:43:24Z″,
  ″proofPurpose″: ″assertionMethod″,
  ″verificationMethod″: ″ did:user:aa76e12ec2lebfeb1f712ebc6aa#keys-
1″.
  ″jws″:
″eyJhbGci0iJSUzI1NiIsImI2NCI6ZmFsc2UsImNyaXQi01siYjY0I119..TCYt5X
    sITJX1CxPCT8yAV-TVkIEq_PbCh0MqsLRoPsnsgw5WEuts01mq-
pQy7UJiN5mgRxD-WUc
    X16dUEMG1v50aqzpqh4Qktb3rk-BuQy72IFL0qV0G_zS245-
kronKb78cPN25DG1cTwLtj
    PAYuNzVBAh4vGHSrQyHUdBBPM″
}
}
],
  ‘holder’ : “did:user:aa76e12ec21ebfeb1f712ebc6aa” ,
  “productTransfer” : {
  “seller” : “did:user:aa76e12ec21ebfeb1f712ebc6aa”
  “buyer” : “did:user:35LB7w9ueWbagPL94T9bMLtyXDj9pX5o”
}
″proof″: {
  ″type″: ″RsaSignature2018″,
  ″created″: ″ 2010-03-10T19:43:24Z″,
  ″proofPurpose″: ″assertionMethod″,
  ″verificationMethod″: ″did:user:aa76e12ec21ebfeb1f712ebc6aa#keys-
1″,
  ″jws″:
″eyJhbGci0iJSUzI1NiIsImI2NCI6ZmFsc2UsImNyaXQi01siYj0I119..TCYt5X
    sITJX1CxPCT8yAV-TVkIEq_PbCh0MqsLfRoPsnsgw5WEuts01mq-
pQy7UJiN5mgRxD-WUc
    X16dUEMG1v50aqzpqh4Qktb3rk-BuQy72IFL0qV0G_zS245-
kronKb78cPN25DG1cTwLtj
    PAYuNzVBAh4vGHSrQyHUdBBPM″
}
}
```

Referring to pseudo code 3, the product transfer VP is a VP proving that, when an initial owner desires to transfer a corresponding product to a third party, the initial owner is the authentic owner of the product. Here, the product transfer VP may be registered in a blockchain by a user terminal device of a buyer (transferee).

The type of VC may be composed of “VerifiablePresentation” and “ProductTransferCredential”, and information configuration of VP may include initial owner VC information of the product so as to prove that the owner of the product is the user himself or herself, and may include proof related to VP information as a public key used to generate the initial owner VC. Also, the product transfer VP may include proof information in which “productTransfer” information representing ID information of a seller (transferor) and a buyer (transferee) is also included.

The following pseudo code 4 is for showing an example of a product transferee VC according to an embodiment of the present invention.

```
Pseudo Code 4
{
″@context″: [
  ″https://www.w3.org/2018/credentials/v1″,
  ″https://www.w3.org/2018/credentials/examples/v1″
  ],
″id″: ″did:user:35LB7w9ueWbagPL94T9MLtyXDj9pX5o/vc/1″,
″type″: [″VerifiableCredential″, ″DisputeCredential″ ,
″ProductOwnershipCredential″],
″issuer″: ″did:user:35LB7w9ueWbagPL94T9bMLtyXDj9pX5o″,
″issuanceDate″: ″2010-30-10T19:23:34Z″,
″credentialSubject″: {
    “id” : “http://manufactuter.com/credentials/1872”,
    “currentStatus” : “P0T” ,
    “statusReason” : {
      “value” : “Product Owner Transfer” ,
      “lang” : “en”
    }
    “purchaseDate” : “2010-03-10T19:23:34Z” ,
    “merkleRoot” :
41DA746DA11463BFE806A64CDBF6233361D96CB6A1534F8DB0CC019ABC4E6514,
    “previousTx” :
  “2A621730E8810CCDAB8E3D361CB4EBC84B82D139D4190D519AFE7D3708CAB200” ,
    “evidenceTx” :
  “007002914EE6C4DACA145D23F9397B22DE06810572A7A07A21AD696AB8776DDE”
},
″proof″: {
  ″type″: ″RsaSignature2018″,
  ″created″: ″ 2010-03-10T19:23:44Z″,
  ″proofPurpose″: ″assertionMethod″,
  ″verificationMethod″: ″ did:user:aa76e12ec21ebfeb1f712ebc6aa#keys-
1″,
  ″jws″:
″eyJhbGci0iJSUzI1NiIsImI2NCI6ZmFsc2UsImNyaXQi01siYjY0I119..TCYt5X
    sITJX1CxPCT8yAV-TVkIEq_PbCh0MqsLfRoPsnsgw5WEuts01mq-
pQy7UJiN5mgRxD-WUc
    X16dUEMG1v50aqzpqh4Qktb3rk-BuQy72IFL0qV0G_ zS245-
kronKb78cPN25DG1cTwLtj
    PAYuNzVBAh4vGHSrQyHUdBBPM″
}
}
```

Referring to pseudo code 4, the product transferee VC is a VC in which a new owner of a transferred product is registered. The type of VC is identical to that of the initial owner VC, and is also identical thereto in a scheme for setting Merkle root (merkleRoot) and transaction (previousTx). However, the product transferee VC must include evidence information indicating that the current owner (seller or transferor) transfers the corresponding product to a transferee (a buyer or a new owner), wherein such evidence information is a value obtained by hashing the ID of the product transfer VP in SHA256.

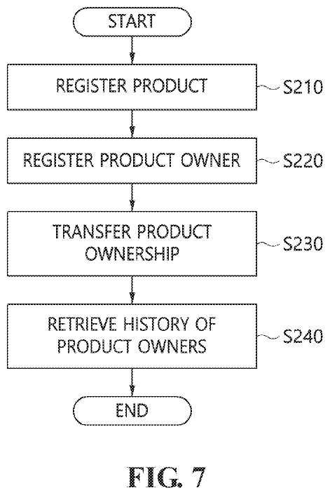

FIG. 7 is an operation flowchart illustrating a method for managing a history of object owners (hereinafter also referred to as an “object owner history management method”) according to an embodiment of the present invention.

Referring to FIG. 7, the object owner history management method according to the embodiment of the present invention may first register a product at step S210.

That is, at step S210, an object owner history management apparatus 100 may generate a product registration Verifiable Credential (VC) in the form of a Merkle tree and register the product registration VC in a blockchain 20 in order to manage a history of owners of an object (i.e., the product).

Here, at step S210, a Decentralized Identifier (DID) and a serial number (S/N) of the object (i.e., the product), owners of which are to be managed, may be generated and assigned, and may be registered, together with the product registration VC, in the blockchain 20.

At step S210, the object owner history management apparatus 100 may generate the product registration VC which includes a hash value, obtained by including the identifier (ID) of the product registration VC in each of the Merkle root and the transaction of the Merkle tree and by hashing the included results thereof.

The product registration VC may include various types of information required for buyers who purchase the product, such as the S/N of the corresponding product, the hash value of the ID of the product registration VC, a product name, a product image, a manufacturer name, a manufacturer contact number, and a random key.

At step S210, the object owner history management apparatus 100 may request the blockchain 20 to register the product registration VC.

At step S210, the blockchain 20 may verify the signature (proof) and Merkle tree information of the product registration VC through a VC/VP management smart contract.

Here, at step S210, the blockchain 20 may record the product registration VC so that the hash value of the identifier (ID) of the product registration VC corresponds to a key for searching for the product registration VC.

That is, at step S210, the blockchain 20 may use a key for retrieving the product registration VC as the hash value of the ID of the product registration VC, and may register a value as entire data of the product registration VC.

Here, at step S210, the blockchain 20 may transmit the results of registration of the product registration VC, together with the hash value of the ID of the product registration VC, to the object owner history management apparatus 100.

Here, at step S210, when the results of registration of the product registration VC are received from the blockchain 20, the object owner history management apparatus 100 may store the registration results in a local database (DB), may generate a random key for retrieving product information, and may store product information including values, such as the hash value of the ID of the product registration VC, the serial number (S/N) of a product, a product name, a product image, and a manufacture date, in the local DB.

Here, at step S210, the object owner history management apparatus 100 may generate a QR code containing the hash value of the serial number (S/N) and a URL, which correspond to access information for accessing the product registration VC recorded in the blockchain 20.

Here, at step S210, the object owner history management apparatus 100 may generate a QR code containing detailed information of the product and information (i.e., a random value (S/N hash value) and a URL) that enables acquisition and retrieval of the product registration VC. The QR code may be enclosed with the product to be sold by a manufacturer, and may be sold and delivered by the manufacturer.

Next, the object owner history management method according to the embodiment of the present invention may register a product owner at step S220.

That is, at step S220, in order for a first user terminal device 10 of an initial owner to register the ownership of the object (product), the first user terminal device 10 may acquire the product registration VC from the blockchain 20, and may register an initial owner VC, which is generated based on the product registration VC, in the blockchain 20.

At step S220, the first user terminal device 10 may acquire the S/N hash value or the URL contained in the QR code of the product by reading the QR code.

Here, at step S220, the first user terminal device 10 may request product information from the object owner history management apparatus 100 by accessing the object owner history management apparatus 100 from the random value (S/N hash value) and the URL which are contained in the QR code.

At step S220, the object owner history management apparatus 100 may transmit product information including the hash value of the ID of the product registration VC, the serial number (S/N), the product name, the product image, the manufacture date, the manufacturer, etc. to the first user terminal device 10 that reads the QR code.

At step S220, the first user terminal device 10 may check the product information received from the object owner history management apparatus 100, and may determine whether the product information matches the product information of the product, the QR code of which is read.

Here, at step S220, the first user terminal device 10 may request the blockchain 20 to retrieve the product registration VC using the hash value of the ID of the product registration VC included in the received product information.

Here, at step S220, the blockchain 20 may retrieve the registered product registration VC using the hash value of the ID of the product registration VC, and may respond to the first user terminal device 10 with the results of retrieval of the product registration VC.

In other words, at step S220, proof of the received product registration VC may be verified, and whether the S/N, the product name, the manufacturer, the product image, the manufacture date, etc. set forth in the product registration VC match the product information of an actual product may be verified.

At step S220, the first user terminal device 10 may generate the initial owner VC by including the ID of the product registration VC in a transaction that is used as evidence information for proving that the owner is the initial owner of the object.

Here, at step S220, the first user terminal device 10 may generate the initial owner VC from a hash value obtained by hashing the ID of the product registration VC and the ID of the initial owner VC.

Here, at step S220, the first user terminal device 10 may send an initial owner VC registration request message including the S/N hash value and the entire data of the initial owner VC to the blockchain 20.

Here, at step S220, whether the initial owner VC included in the received initial owner VC registration request message is registered is determined. If it is determined that the initial owner VC is not registered, the Merkle tree and proof of the initial owner VC may be verified.

Here, at step S220, when verification of the initial owner VC has succeeded, the hash value of the ID of the initial owner VC may be registered as a key for retrieving the initial owner VC, and the entire data of the initial owner VC may be registered as a value.

At step S220, the S/N hash value included in the received initial owner VC registration request message may be registered as a key for retrieving the S/N, and the hash value of the ID of the initial owner VC may be registered as the value for retrieving the hash value of the ID of the initial owner VC from the S/N.

At this time, at step S220, the blockchain 20 may transmit the results of registration of the initial owner VC to the first user terminal device 10.

Next, the object owner history management method according to the embodiment of the present invention may transfer product ownership at step S230.

That is, at step S230, a second user terminal device 30 of a transferee (i.e., a buyer or a new owner) may acquire a product transfer Verifiable Presentation (VP) from the first user terminal device 10 and register a transferee VC, generated based on the product transfer VP, in the blockchain, in order to receive transfer of the ownership of the object (product) from the first user terminal device 10 of the initial owner (i.e., a seller or transferor).

At step S230, the second user terminal device 30 may provide its own decentralized identifier (DID) to the first user terminal device 10 in order to receive transfer of the ownership of the product.

For example, at step S230, the second user terminal device 30 may generate and output a QR code containing its own DID in order to receive transfer of the ownership of the product.

Here, at step S230, when the first user terminal device 10 reads the output QR code, the first user terminal device 10 may generate the product transfer VP.

At step S230, the second user terminal device 30 may generate information including its own Decentralized ID (DID) in addition to the QR code, and may provide the generated information to the first user terminal device 10 through any of various types of communication schemes such as Bluetooth or near-field communication.

Here, at step S230, the first user terminal device 10 may generate the product transfer VP including the DID of the second user terminal device 30, which is acquired from the second user terminal device 30.

At step S230, the first user terminal device 10 may generate the product transfer VP including evidence information for receiving transfer of the ownership of the product and the initial owner VC using the DID of the first user terminal device 10 (seller DID) and the DID of the second user terminal device 30 (buyer DID).

Also, at step S230, the second user terminal device 10 may provide the product transfer VP to the second user terminal device 30 desiring to receive transfer of the ownership of the product.

Here, at step S230, the first user terminal device 10 may output the QR code to provide the product transfer VP, and the second user terminal device 30 may receive the product transfer VP from the first user terminal device 10 upon reading the output QR code.

At step S230, the first user terminal device 10 may generate information including the product transfer VP in addition to the QR code, and may provide the information to the second user terminal device 30 through any of various types of communication schemes, such as Bluetooth or near-field communication.

Here, at step S230, the second user terminal device 30 may check the decentralized identifier (DID) of the product transfer VP included in the product transfer VP.

Here, at step S230, the second user terminal device 30 may check whether a holder DID, a seller DID of “productTransfer”, and an issuer DID, which are included in the product transfer VP, match those of the actual information.

That is, at step S230, the second user terminal device 30 may check whether a buyer DID in “productTransfer” of the product registration VC matches the buyer's own DID.

At step S230, the second user terminal device 30 may request the blockchain 20 to retrieve the VC using the hash value (PreviousTx) of the ID of the VC included in the product transfer VP.

Here, at step S230, the blockchain 20 may retrieve a VC corresponding to the hash value of the ID of the requested VC, and may transmit the retrieved VC to the second user terminal device 30.

Here, at step S230, the second user terminal device 30 may retrieve a history of owners of the object (product) from the blockchain 20 using the hash value of the ID of the initial owner VC included in the product transfer VP.

Here, at step S230, the second user terminal device 30 may determine whether a Merkle root (merkleRoot) and transaction (previousTx) in the received VC are identical to each other, may determine that the received VC is a product registration VC when they are identical to each other, and may repeatedly retrieve the transactions (PreviousTx) of owner VCs retrieved from the blockchain 20 until the product registration VC is retrieved when they are not identical to each other, thus enabling a history of product owners from the retrieved owner VCs to be retrieved.

Here, at step S230, the second user terminal device 30 may verify whether product information, such as the serial number (S/N), product name, manufacturer, and manufacture date set forth in the product registration VC, matches those of the actual product.

That is, at step S230, the second user terminal device 30 may output a history of product owners, including a history from the initial product manufacture date to the recent purchase date, to the user.

Here, at step S230, the second user terminal device 30 may generate the transferee VC (buyer VC) by including the ID of the product transfer VP in a transaction that is used as evidence information for transferring the ownership of the product.

At step S230, the second user terminal device 30 may generate the transferee VC including a hash value obtained by hashing the ID of the product transfer VP and the ID of the transferee VC and a hash value obtained by hashing the ID of the initial owner VC.

At step S230, the second user terminal device 30 may generate a product transferee VC registration request message including an S/N hash value, entire data of the product transfer VP, and entire data of the transferee VC.

At step S230, the second user terminal device 30 may request the blockchain 20 to register the transferee VC by sending the product transferee VC registration request message to the blockchain 20.

Here, at step S230, the blockchain 20 may verify the Merkle trees, the transfer relationships (evidenceTx), and the proofs of the transferee VC and the product transfer VP.

That is, at step S230, when verification succeeds, the blockchain 20 may record the hash value of the ID of the transferee VC as a key, and may record the entire data of the transferee VC as a value.

That is, at step S230, when verification succeeds, the blockchain 20 may record the hash value of the ID of the product transfer VP as a key, and may record the entire data of the product transfer VP as a value.

Here, at step S230, when verification succeeds, the blockchain 20 may record an S/N hash value as a key, and may record the hash value of the ID of the transferee VC as a value, thus updating S/N management information.

Further, at step S230, the blockchain 20 may respond to the second user terminal device 30 with the results of registration of the transferee VC.

Next, the object owner history management method according to the embodiment of the present invention may retrieve a history of product owners at step S240.

That is, at step S240, the user terminal device 10 may retrieve the history of owners of the product from the blockchain 20 using the hash value of the serial number (S/N) of the product.

Here, at step S240, the user terminal device 10 may check received product S/N information.

At step S240, the user terminal device 10 may generate a hash value by hashing the received product S/N information.

Here, at step S240, the user terminal device 10 may request the blockchain 20 to retrieve the history of product owners using the hash value of the product S/N information.

Here, at step S240, the blockchain 20 may retrieve the hash value of the ID of the final owner VC registered as the hash value of the product S/N information.

Here, at step S240, the blockchain 20 may retrieve the final owner VC registered as the hash value of the ID of the final owner VC.

Here, at step S240, the blockchain 20 may check whether the Merkle root (merkleRoot) and the transaction (previousTx) of the final owner VC are identical to each other. When they are identical to each other, the blockchain 20 may determine the final owner VC to be the product registration VC, whereas when they are not identical to each other, the blockchain 20 may repeatedly retrieve the transactions (PreviousTx) of the retrieved owner VCs until the product registration VC is retrieved, and may then generate product owner history data from the retrieved owner VC.

Here, at step S240, the blockchain 20 may transmit the generated product owner history data to the user terminal device 10.

Here, at step S240, the user terminal device 10 may output the history of product owners, including a history from the initial product manufacture date to the recent purchase date, to the user.

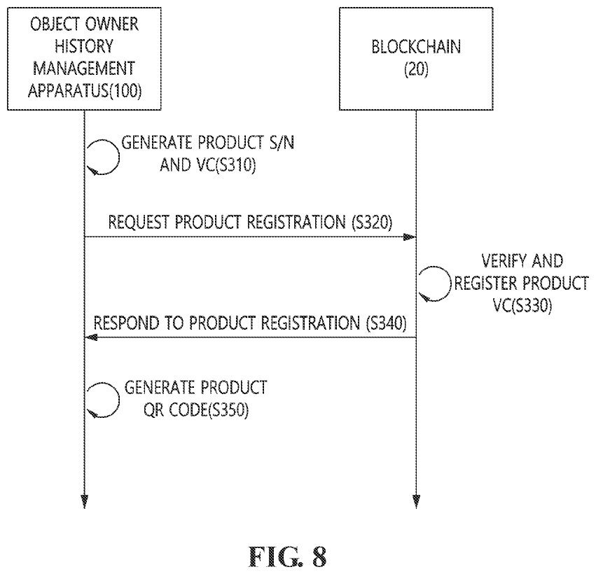

FIG. 8 is a sequence diagram illustrating a product registration process according to an embodiment of the present invention.

Referring to FIG. 8, the object owner history management apparatus 100 may generate a product registration Verifiable Credential (VC) in the form of a Merkle tree and register the product registration VC in a blockchain 20, in order to manage a history of owners of an object (product).

At step S310, a Decentralized Identifier (DID) and a serial number (S/N) of an object (product), the history of owners of which is to be managed, may be generated and assigned.

At step S310, the object owner history management apparatus 100 may generate the product registration VC which includes a hash value, obtained by including the identifier (ID) of the product registration VC in each of the Merkle root and the transaction of the Merkle tree and by hashing the included results thereof.

The product registration VC may include various types of information required for buyers who purchase the product, such as the S/N of the corresponding product, the hash value of the ID of the product registration VC, a product name, a product image, a manufacturer name, a manufacturer contact number, and a random key.

At step S320, the object owner history management apparatus 100 may request the blockchain 20 to register the product registration VC.

At step S330, the blockchain 20 may record the product registration VC so that the hash value of the identifier (ID) of the product registration VC corresponds to a key for searching for the product registration VC.

At step S330, the blockchain 20 may verify the signature (proof) and Merkle tree information of the product registration VC through a VC/VP management smart contract.

That is, at step S330, the blockchain 20 may use a key for retrieving the product registration VC as the hash value of the ID of the product registration VC, and may register a value as entire data of the product registration VC.

At step S340, the blockchain 20 may transmit the results of registration of the product registration VC, together with the hash value of the ID of the product registration VC, to the object owner history management apparatus 100.

Here, at step S340, when the results of registration of the product registration VC are received from the blockchain 20, the object owner history management apparatus 100 may store the registration results in a local database (DB), may generate a random key for retrieving product information, and may store product information including values, such as the hash value of the ID of the product registration VC, the serial number (S/N) of a product, a product name, a product image, and a manufacture date, in the local DB.

At step S350, the object owner history management apparatus 100 may generate a QR code containing the hash value of the serial number (S/N) and a URL, which correspond to access information for accessing the product registration VC recorded in the blockchain 20.

Here, at step S350, the object owner history management apparatus 100 may generate a QR code containing detailed information of the product and information (i.e., a random value (S/N hash value) and a URL) that enables acquisition and retrieval of the product registration VC. The QR code may be enclosed with the product to be sold by a manufacturer, and may be sold and delivered by the manufacturer.

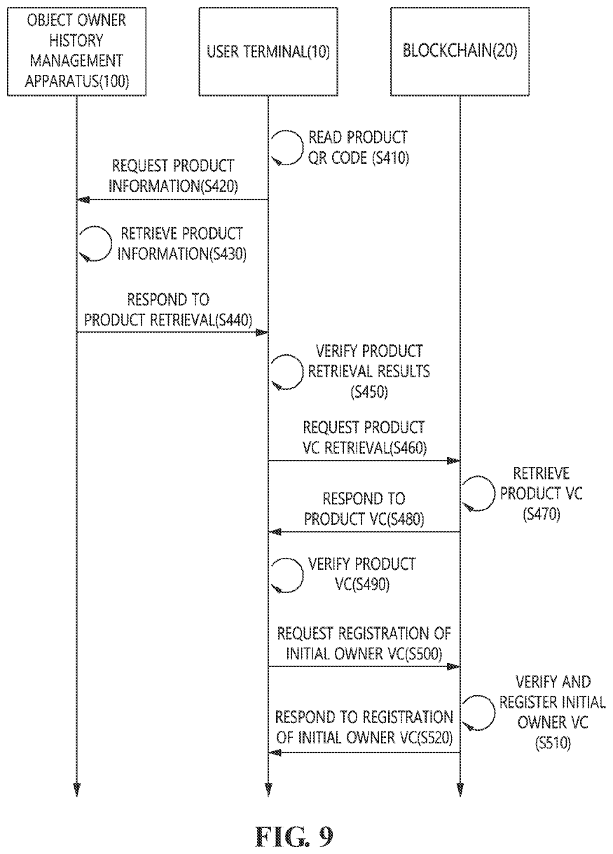

FIG. 9 is a sequence diagram illustrating a product owner registration process according to an embodiment of the present invention.

Referring to FIG. 9, it can be seen that, in order for a first user terminal device 10 of an initial owner to register the ownership of the object (product), the first user terminal device 10 acquires the product registration VC from the blockchain 20, and registers an initial owner VC, which is generated based on the product registration VC, in the blockchain 20.

At step S410, the first user terminal device 10 may read the QR code of the product, and may then acquire an S/N hash value contained in the QR code of the product, or a URL through which product information is to be provided.

Here at step S410, the first user terminal device 10 may acquire the S/N hash value or the URL for the product through various methods, such as a reference site for the product and an application provided by the product.

At step S420, the first user terminal device 10 may request product information from the object owner history management apparatus 100 by accessing the object owner history management apparatus 100 from the acquired random value (S/N hash value) and URL.

At step S430, the object owner history management apparatus 100 may retrieve product information stored in a local DB using the random value.

At step S440, the object owner history management apparatus 100 may transmit product information including the hash value of the ID of the product registration VC, the serial number (S/N), the product name, the product image, the manufacture date, the manufacturer, etc. to the first user terminal device 10 that reads the QR code.

At step S450, the first user terminal device 10 may check the product information received from the object owner history management apparatus 100, and may determine whether the product information matches the product information of the product, the QR code of which is read.

At step S460, the first user terminal device 10 may request the blockchain 20 to retrieve the product registration VC using the hash value of the ID of the product registration VC included in the received product information.

At step S470, the blockchain 20 may retrieve the registered product registration VC using the hash value of the ID of the product registration VC.

At step S480, the blockchain 20 may respond to the first user terminal device 10 with the results of retrieval of the product registration VC.

At step S490, the first user terminal device 10 may verify the proof of the received product registration VC, and may verify whether the S/N, the product name, the manufacturer, the product image, the manufacture date, etc. set forth in the product registration VC match the product information of an actual product.

Here, at step S490, the first user terminal device 10 may generate the initial owner VC by including the ID of the product registration VC in a transaction that is used as evidence information for proving that the owner is the initial owner of the object.

Here, at step S490, the first user terminal device 10 may generate the initial owner VC from a hash value obtained by hashing the ID of the product registration VC and the ID of the initial owner VC.

At step S500, the first user terminal device 10 may send an initial owner VC registration request message including the S/N hash value and the entire data of the initial owner VC to the blockchain 20.

At step S510, whether the initial owner VC included in the received initial owner VC registration request message is registered is determined. If it is determined that the initial owner VC is not registered, the Merkle tree and proof of the initial owner VC may be verified.

Here, at step S510, when verification of the initial owner VC has succeeded, the hash value of the ID of the initial owner VC may be registered as a key for retrieving the initial owner VC, and the entire data of the initial owner VC may be registered as a value.

Here, at step S510, the S/N hash value included in the received initial owner VC registration request message may be registered as a key for retrieving the S/N. and the hash value of the ID of the initial owner VC may be registered as the value for retrieving the hash value of the ID of the initial owner VC from the S/N.

At step S520, the blockchain 20 may transmit the results of registration of the initial owner VC to the first user terminal device 10.

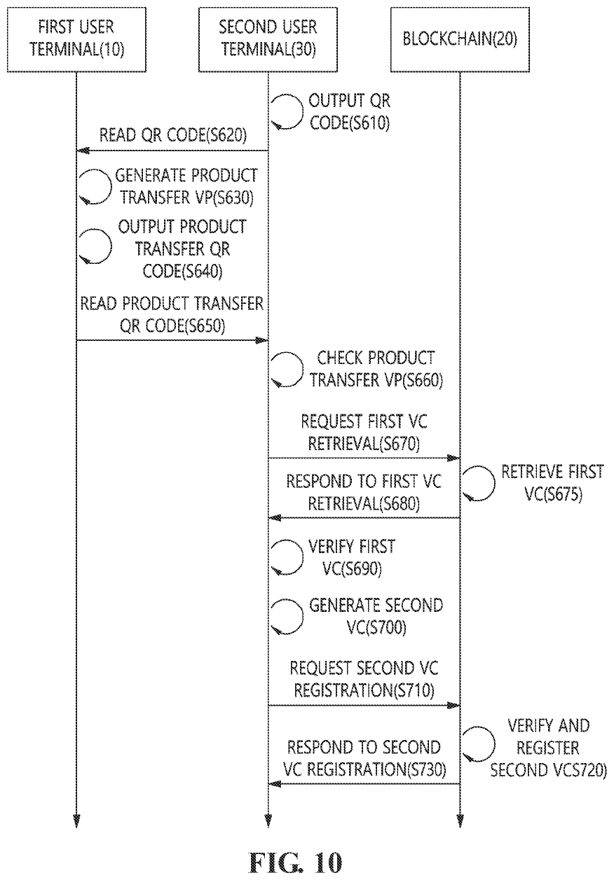

FIG. 10 is a sequence diagram illustrating a product transfer and transferee registration process according to an embodiment of the present invention.

Referring to FIG. 10, it can be seen that a second user terminal device 30 of a transferee (i.e., a buyer or a new owner) acquires a product transfer Verifiable Presentation (VP) from the first user terminal device 10 and registers a transferee VC, generated based on the product transfer VP, in the blockchain, in order to receive transfer of ownership of an object (product) from the first user terminal device 10 of the initial owner (i.e., a seller or transferor).

At step S610, the second user terminal device 30 may generate and output a QR code containing its own DID in order to receive transfer of the ownership of the product.

At step S620, the first user terminal device 10 may read the output QR code.

At step S630, when the first user terminal device 10 reads the output QR code, a product transfer VP may be generated.

Here, at step S630, the first user terminal device 10 may generate the product transfer VP including evidence information for receiving transfer of the ownership of the product and the initial owner VC using the DID of the first user terminal device 10 (seller DID) and the DID of the second user terminal device 30 (buyer DID).

At step S640, the second user terminal device 10 may generate a QR code for transmitting the product transfer VP to the second user terminal device 30 desiring to receive transfer of the ownership of the product, and may output the QR code.

At step S650, when the second user terminal device 30 reads the output QR code, the second user terminal device 30 may receive the product transfer VP from the first user terminal device 10.

At step S660, the second user terminal device 30 may check the DID of the product transfer VP included in the product transfer VP.

Here, at step S660, the second user terminal device 30 may check whether a holder DID, a seller DID of “productTransfer”, and an issuer DID, which are included in the product transfer VP, match those of the actual information.

Here, at step S660, the second user terminal device 30 may check whether a buyer DID in “productTransfer” of the product registration VC matches the buyer's own DID.

At step S670, the second user terminal device 30 may request the blockchain 20 to retrieve the VC using the hash value (previousTX) of the ID of the VC included in the product transfer VP.

At step S675, the blockchain 20 may retrieve the VC corresponding to the hash value of the ID of the requested VC.

Here, at step S675, the second user terminal device 30 may retrieve a history of owners of the object (product) from the blockchain 20 using the hash value of the ID of the initial owner VC included in the product transfer VP.

At step S680, the blockchain 20 may transmit the retrieved VC to the second user terminal device 30.

Here, at step S680, the second user terminal device 30 may determine whether a Merkle root (merkleRoot) and transaction (previousTx) in the received VC are identical to each other, may determine that the received VC is a product registration VC when they are identical to each other, and may repeatedly retrieve the transactions (PreviousTx) of owner VCs retrieved from the blockchain 20 until the product registration VC is retrieved when they are not identical to each other, thus enabling a history of product owners from the retrieved owner VCs to be retrieved.

Here, at step S680, the second user terminal device 30 may output a history of product owners, including a history from the initial product manufacture date to the recent purchase date, to the user.

At step S690, the second user terminal device 30 may verify whether product information, such as the serial number (S/N), product name, manufacturer, and manufacture date set forth in the product registration VC, matches those of the actual product.

At step S700, the second user terminal device 30 may generate the transferee VC (buyer VC) by including the ID of the product transfer VP in a transaction that is used as evidence information for transferring the ownership of the product.

Here, at step S700, the second user terminal device 30 may generate the transferee VC including a hash value obtained by hashing the ID of the product transfer VP and the ID of the transferee VC and a hash value obtained by hashing the ID of the initial owner VC.

At step S710, the second user terminal device 30 may generate a product transferee VC registration request message including an S/N hash value, entire data of the product transfer VP, and entire data of the transferee VC.

Here, at step S710, the second user terminal device 30 may request the blockchain 20 to register the transferee VC by sending the product transferee VC registration request message to the blockchain 20.

At step S720, the blockchain 20 may verify the Merkle trees, the transfer relationships (evidenceTx), and the proofs of the transferee VC and the product transfer VP.

Here, at step S720, when verification succeeds, the blockchain 20 may record the hash value of the ID of the transferee VC as a key, and may record the entire data of the transferee VC as a value.

Here, at step S720, when verification succeeds, the blockchain 20 may record the hash value of the ID of the product transfer VP as a key, and may record the entire data of the product transfer VP as a value.

Here, at step S720, when verification succeeds, the blockchain 20 may record an S/N hash value as a key, and may record the hash value of the ID of the transferee VC as a value, thus updating S/N management information.

At step S730, the blockchain 20 may respond to the second user terminal device 30 with the results of registration of the transferee VC.

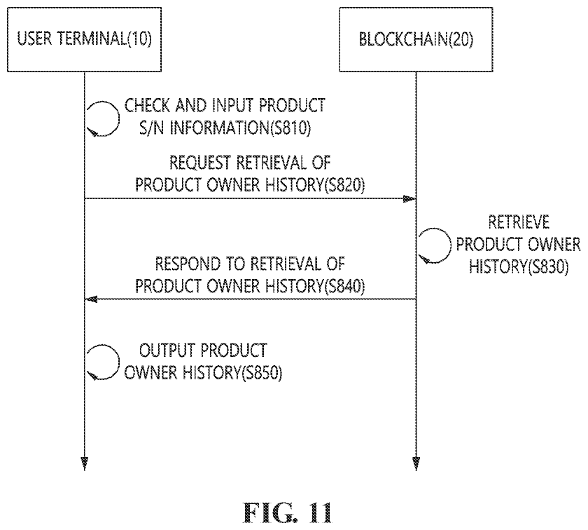

FIG. 11 is a sequence diagram illustrating a product owner history retrieval process according to an embodiment of the present invention.

Referring to FIG. 11, it can be seen that the user terminal device 10 retrieves a history of owners of the product from the blockchain 20 using the hash value of the serial number (S/N) of the product.

At step S810, the user terminal device 10 may check received product S/N information.

Here, at step S810, the user terminal device 10 may generate a hash value by hashing the received product S/N information.

At step S820, the user terminal device 10 may request the blockchain 20 to retrieve the history of product owners using the hash value of the product S/N information.

At step S830, the blockchain 20 may retrieve the hash value of the ID of the final owner VC registered as the hash value of the product S/N information.

Here, at step S830, the blockchain 20 may retrieve the final owner VC registered as the hash value of the ID of the final owner VC.

Here, at step S830, the blockchain 20 may check whether the Merkle root (merkleRoot) and the transaction (previousTx) of the final owner VC are identical to each other. When they are identical to each other, the blockchain 20 may determine the final owner VC to be the product registration VC, whereas when they are not identical to each other, the blockchain 20 may repeatedly retrieve the transactions (PreviousTx) of the retrieved owner VCs until the product registration VC is retrieved, and may then generate product owner history data from the retrieved owner VC.

At step S840, the blockchain 20 may transmit the generated product owner history data to the user terminal device 10.

At step S850, the user terminal device 10 may output the history of product owners, including a history from the initial product manufacture date to the recent purchase date, to the user.

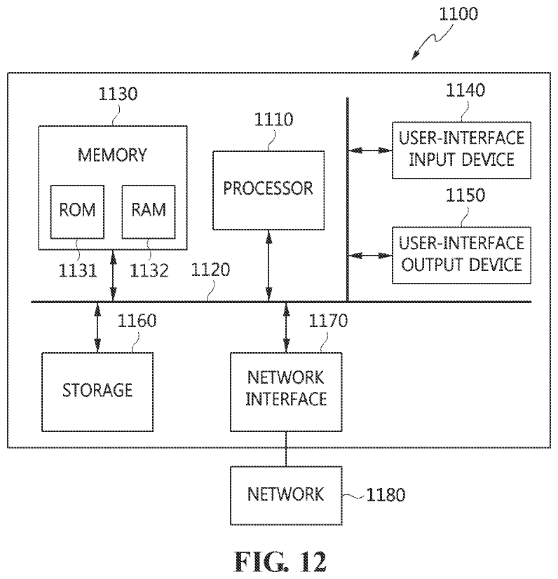

FIG. 12 is a block diagram illustrating a computer system according to an embodiment of the present invention.

Referring to FIG. 12, the object owner history management apparatus 100, the user terminal device 10, and nodes of the blockchain system 20 according to embodiments of the present invention may be implemented in a computer system 1100, such as a computer-readable storage medium. As illustrated in FIG. 12, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

The object owner history management apparatus according to an embodiment of the present invention may include one or more processors 1110 and execution memory 1130 for storing at least one program that is executed by the one or more processors 1110, wherein the at least one program is configured to, in order to manage a history of owners of an object that is a product, generate a product registration Verifiable Credential (VC) in a form of a Merkle tree, register the product registration VC in a blockchain, register the product registration VC in the blockchain, and provide an identifier of the product registration VC for accessing the blockchain to a user terminal device desiring to register an ownership of the object.

Here, the user terminal device may be configured to acquire the product registration VC from the blockchain in order to register ownership of the object, and register a first owner VC, generated based on the product registration VC, in the blockchain, and to acquire a product transfer Verifiable Presentation (VP) from a user terminal device of an initial owner and register a second owner VC, generated based on the product transfer VP, in the blockchain in order to receive transfer of the ownership of the object.

Here, the at least one program may be configured to generate the product registration VC including a hash value obtained by including an identifier of the product registration VC in each of a Merkle root and a transaction of the Merkle tree and by performing hashing on included results thereof.

Here, the first owner VC may include an identifier of the product registration VC in a transaction that is used as evidence information for proving that the first owner is an initial owner of the object.

Here, the second owner VC may include an identifier of the product transfer VP in a transaction that is used as evidence information for transferring an ownership of the object.

Here, the second owner VC may correspond to a hash value obtained by hashing the identifier of the product transfer VP and an identifier of the second owner VC and a hash value obtained by hashing an identifier of the initial owner VC of the initial owner.

The present invention may provide secure commercial transaction service by verifying and managing histories of owners of objects, such as all articles distributed through commercial transaction services.

Further, the present invention may apply the technology of the present invention to various types of history management services as well as to the management of histories of owners of objects.

As described above, in the apparatus and method for managing a history of object owners according to the present invention, the configurations and schemes in the above-described embodiments are not limitedly applied, and some or all of the above embodiments can be selectively combined and configured so that various modifications are possible.

What is claimed is:

1. A method for managing a history of object owners using an object owner history management apparatus, the method comprising:
generating, by the object owner history management apparatus, a product registration Verifiable Credential (VC) in a form of a Merkle tree, and registering the product registration VC in a blockchain in order to manage a history of owners of an object that is a product;
acquiring, by a first user terminal device, the product registration VC from the blockchain and registering a first owner VC, generated based on the product registration VC, in the blockchain in order to register an ownership of the object; and
acquiring, by a second user terminal device, a product transfer Verifiable Presentation (VP) from the first user terminal device and registering a second owner VC, generated based on the product transfer VP, in the blockchain in order to receive transfer of the ownership of the object.

2. The method of claim 1, wherein registering the product registration VC is configured such that the object owner history management apparatus generates the product registration VC including a hash value obtained by including an identifier of the product registration VC in each of a Merkle root and a transaction of the Merkle tree and by performing hashing on included results thereof.

3. The method of claim 2, wherein registering the product registration VC is configured such that the blockchain records the product registration VC in the blockchain so that the hash value of the identifier of the product registration VC corresponds to a key for searching for the product registration VC.

4. The method of claim 3, wherein registering the product registration VC is configured such that the object owner history management apparatus generates a Quick Response (QR) code including access information required to access the product registration VC recorded in the blockchain.

5. The method of claim 3, wherein registering the first owner VC is configured such that the first user terminal device acquires the hash value of the identifier of the product registration VC from the object owner history management apparatus and acquires the product registration VC from the blockchain using the hash value of the identifier of the product registration VC as a key.

6. The method of claim 5, wherein registering the first owner VC is configured such that the first user terminal device generates the first owner VC by including the identifier of the product registration VC in a transaction that is used as evidence information for proving that the first owner is an initial owner of the object.

7. The method of claim 6, wherein registering the first owner VC is configured such that the first user terminal device generates the first owner VC from a hash value obtained by hashing the identifier of the product registration VC and an identifier of the first owner VC.

8. The method of claim 7, wherein registering the first owner VC is configured such that:
the first user terminal device transmits a hash value of a serial number of the object acquired from the product registration VC and the first owner VC to the blockchain, and
the blockchain registers the first owner VC and records the first owner as an initial owner in a history of owners based on the serial number.

9. The method of claim 8, wherein registering the second owner VC is configured such that the second user terminal device provides a decentralized identifier thereof to the first user terminal device so as to receive transfer of ownership of the object.

10. The method of claim 9, wherein registering the second owner VC is configured such that the first user terminal device generates evidence information for transferring an ownership of the object using a decentralized identifier of the first user terminal device and a decentralized identifier of the second user terminal device, and generates the product transfer VP including the evidence information and the first owner VC.

11. The method of claim 10, wherein registering the second owner VC is configured such that the second user terminal device retrieves a history of owners of the object from the blockchain using the hash value of the identifier of the first owner VC included in the product transfer VP.

12. The method of claim 11, wherein registering the second owner VC is configured such that the second user terminal device generates the second owner VC by including an identifier of the product transfer VP in a transaction that is used as evidence information for transferring an ownership of the object.

13. The method of claim 12, wherein registering the second owner VC is configured such that the second user terminal device generates the second owner VC including a hash value, obtained by hashing the identifier of the product transfer VP and an identifier of the second owner VC, and a hash value, obtained by hashing the identifier of the first owner VC.

14. The method of claim 13, wherein registering the second owner VC is configured such that:
the second user terminal device transmits a hash value of a serial number of the object acquired from the first owner VC, the product transfer VP, and the second owner VC to the blockchain, and
the blockchain registers the second owner VC and records the second owner as a transferee in the history of owners based on the serial number.

15. An apparatus for managing a history of object owners, comprising:
one or more processors; and
an execution memory for storing at least one program that is executed by the one or more processors,
wherein the at least one program is configured to:
in order to manage a history of owners of an object that is a product, generate a product registration Verifiable Credential (VC) in a form of a Merkle tree, register the product registration VC in a blockchain, register the product registration VC in the blockchain, and provide an identifier of the product registration VC for accessing the blockchain to a user terminal device desiring to register an ownership of the object.

16. The apparatus of claim 15, wherein the user terminal device is configured to:
acquire the product registration VC from the blockchain in order to register ownership of the object, and register a first owner VC, generated based on the product registration VC, in the blockchain, and
acquire a product transfer Verifiable Presentation (VP) from a user terminal device of an initial owner and register a second owner VC, generated based on the product transfer VP, in the blockchain in order to receive transfer of the ownership of the object.

17. The apparatus of claim 16, wherein the at least one program is configured to generate the product registration VC including a hash value obtained by including an identifier of the product registration VC in each of a Merkle root and a transaction of the Merkle tree and by performing hashing on included results thereof.

18. The apparatus of claim 17, wherein the first owner VC includes an identifier of the product registration VC in a transaction that is used as evidence information for proving that the first owner is an initial owner of the object.

19. The apparatus of claim 18, w % herein the second owner VC includes an identifier of the product transfer VP in a transaction that is used as evidence information for transferring an ownership of the object.

20. The apparatus of claim 19, wherein the second owner VC corresponds to a hash value obtained by hashing the identifier of the product transfer VP and an identifier of the second owner VC and a hash value obtained by hashing an identifier of the initial owner VC of the initial owner.
